(19) United States
(12) Patent Application Publication
(10) Pub. No.: US 2026/0115947 A1
(43) Pub. Date: Apr. 30, 2026

(54) PERSONALCARE APPLIANCE

(71) Applicant: KONINKLIJKE PHILIPS N.V., EINDHOVEN (NL)

(72) Inventor: MARCUS CORNELIS PETRELLI, GRONINGEN (NL)

(21) Appl. No.: 19/472,425

(22) PCT Filed: Apr. 3, 2024
(86) PCT No.: PCT/EP2024/058972

§ 371 Date: Oct. 3, 2025

(30) Foreign Application Priority Data
Apr. 4, 2023 (EP) 23166560.5

(51) Int. Cl. B26B 19/28; B26B 19/06; B26B 19/38

(52) U.S. Cl. CPC B26B 19/28; B26B 19/06; B26B 19/3853

(57) ABSTRACT

The subject-matter of the present disclosure relates to a personal care appliance. The personal care appliance comprises: a handle; a functional device at a head of the handle; a driving bridge for driving the functional device, the driving bridge comprising a slot; a motor within the handle; and a lever coupled between the motor and the driving bridge for reciprocally driving the driving bridge back and forth, the lever comprising a cylinder at a tip inserted in the slot of the driving bridge, wherein the cylinder is inclined with respect to the driving bridge.

### FIELD OF THE INVENTION

The subject-matter of the present disclosure relates to personal care appliances having a driving bridge driven by a motor.

### BACKGROUND OF THE INVENTION

Personal care appliances such as a razor include a functional device (e.g. a cutter), a driving bridge coupled to the cutter, a motor, and a linkage extending between the motor and the driving bridge. The selection of linkage depends on a location of the motor relative to the driving bridge. A motor being proximal to the driving bridge may employ an eccentric. The eccentric may fit in a slot of the driving bridge, the slot forming opposing driving surfaces for the eccentric to push against. However, if the motor is moved further away from the driving bridge, the eccentric may be unsuitable due to loads exerted on the eccentric.

Therefore, a lever may be employed as the linkage. However, a driving bridge designs for use with a motor eccentric may be unsuitable for a lever. This is primarily because a driving surface for use with an eccentric is typically small, e.g. the driving bridge may be comparatively thin. In this way, friction may be reduced. However, when a thin driving bridge is used with a lever, it may be difficult to align the lever with the slot of the driving bridge because of stack tolerances along a length of the personal care appliance.

It is an aim of the subject-matter of the present disclosure to improve on the prior art.

### SUMMARY OF THE INVENTION

According to a first aspect of the present invention, there is provided a personal care appliance comprising: a handle; a functional device at a head of the handle; a driving bridge for driving the functional device, the driving bridge comprising a slot: a motor within the handle; and a lever coupled between the motor and the driving bridge for reciprocally driving the driving bridge back and forth, the lever comprising a cylinder at a tip inserted in the slot of the driving bridge, the slot being provided between opposing driving surfaces, wherein the cylinder is inclined with respect to the driving bridge, wherein a ratio, D/H, of a diameter, D, of the cylinder to a height, H, of the respective driving surfaces, is greater than one.

The cylinder being inclined with respect to the driving bridge means that the driving bridge designed for engagement with a motor eccentric can be used with a lever so that the motor can be moved away from the driving bridge.

In an embodiment, an angle of inclination of the cylinder with respect to the driving bridge is between 10 and 30 degrees.

In an embodiment, the angle of inclination is around 20 degrees.

In an embodiment, the ratio D/H is around 2.2.

In an embodiment, a length of the cylinder is between about 4 and 8 mm.

In an embodiment, the length of the cylinder is governed by: L=e/tan(α)+L_start, where L is the length of the cylinder measured in mm, e is an error range between a highest and a lowest positions of the cylinder in the slot measured in mm, α is the angle of inclination of the cylinder with respect to the slot, and L_start is starting value for the cylinder length in mm assuming e is zero.

In an embodiment, the error, e, is around 1 mm.

In an embodiment, the cylinder axis is substantially parallel to an axis of rotation of the lever.

In an embodiment, the lever comprises a motor end opposite the tip, the motor end having a slot, wherein the motor comprises an eccentric driving mechanism extending in a direction of an axis in which the handle extends, wherein the eccentric driving mechanism is accommodated within the slot of the motor end of the lever.

In an embodiment, the eccentric driving mechanism comprises a substantially spherical shaped tip contained within the slot of the motor end of the lever. In this way, the tip of the eccentric driving mechanism will be less likely to jam in the slot.

In an embodiment, the motor end of the lever comprises a guide for guiding the eccentric driving mechanism therein during assembly. In this way, assembly is made easier and quicker.

In an embodiment, the guide of the motor end of the lever comprises opposing ramps.

In an embodiment, the driving bridge comprises a guide for guiding the tip of the lever to the slot of the driving bridge during assembly. In this way, assembly is quicker and easier.

In an embodiment, the guide of the driving bridge comprises opposing inclined surfaces.

In an embodiment, the lever extends in a direction substantially parallel to the axis in which the handle extends, and optionally wherein the motor is positioned at a distal end of the handle to the head.

In an embodiment, the personal care appliance is a shaver, and the functional device comprises a cutter.

According to an example, there is provided a personal care appliance comprising: a handle; a functional device at a head of the handle; a driving bridge for driving the functional device, the driving bridge comprising a slot; a motor within the handle; and a lever coupled between the motor and the driving bridge for reciprocally driving the driving bridge back and forth, the lever comprising a cylinder at a tip inserted in the slot of the driving bridge, wherein the cylinder is inclined with respect to the driving bridge.

These and other aspects of the present invention will be apparent from and elucidated with reference to the embodiment(s) described hereinafter.

### BRIEF DESCRIPTION OF THE DRAWINGS

The embodiments of the present inventions may be best understood with reference to the accompanying figures, in which:

FIG. 1 shows a perspective view of a head portion of a personal care appliance including a driving bridge and a motor eccentric in a slot thereof;

FIG. 2 shows a perspective view of a section of the head portion of the personal care appliance from FIG. 1;

FIG. 3 shows a perspective view of a head portion of a personal care appliance including a driving bridge and a lever in a slot thereof;

FIG. 4 shows a cross-sectional view of the head portion from FIG. 3;

FIG. 5 shows a perspective view of a head portion of a personal care appliance including a driving bridge and a lever having a tip with a cylinder in a slot of the driving bridge, according to one or more embodiments;

FIG. 6 shows a cross-sectional view of the head portion of FIG. 5; and

FIG. 7 shows a magnified portion of the cross-sectional view from FIG. 6.

### DETAILED DESCRIPTION OF THE EMBODIMENTS

Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

The personal care appliance may be a, for example, handheld apparatus used for personal care or grooming. Personal care appliances include cleaning appliances, skin treatment appliances, hair removal appliances, massage devices, etc. Generally, personal care appliances perform a treatment or an operation to a human or animal body.

Hair cutting appliances and hair grooming appliances are well-known in the art and may comprise, for instance, shavers, razors, trimmers, epilators, hair styling appliances and combinations thereof. Typically, hair grooming appliances comprise an electric motor that is arranged to drive a cutting unit (or cutter), for instance a blade set, so as to effect a hair cutting and/or grooming operation. More generally, hair cutting appliances may be also referred to as grooming appliances.

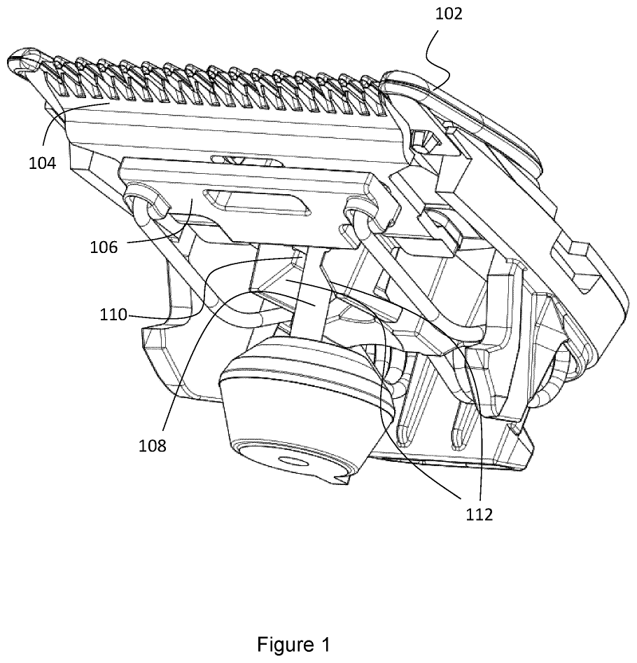

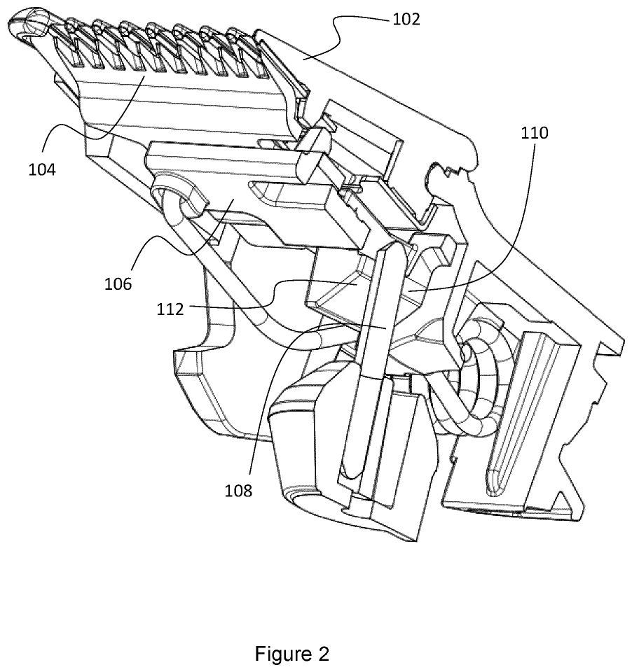

With reference to FIGS. 1 and 2, a personal care appliance in the form of a hair cutting appliance, or shaver, is provided. The personal care appliance includes a guard 102, a functional device (in this case a cutter) 104, a driving bridge 106, and a linkage 108. The cutter 104 and the guard 102 both have a plurality of teeth. The cutter 104 cooperates with the guard 102 by moving back and forth in a reciprocal manner to cut hairs between the respective teeth. The cutter 104 is connected to the driving bridge 106. The driving bridge includes a slot 110. The slot is oriented orthogonally to a direction of movement of the driving bridge 106.

The linkage 108 in FIGS. 1 and 2 is an eccentric driving mechanism because the motor (not shown) is located proximally to the driving bridge 106. The eccentric driving mechanism comprises an elongate stem extending parallel to a rotational axis of the motor. However, the elongate stem is not inline with the rotational axis of the motor but is offset. In this way, the stem provides the eccentric driving mechanism.

The slot 110 is provided between opposing driving surfaces. During operation, the eccentric driving mechanism pushes against the driving surfaces to move the driving bridge 106 in a reciprocal manner during rotation of the motor. To reduce friction between the eccentric driving mechanism and the driving surfaces, the driving surfaces can be comparatively thin. In this way, the driving surfaces have reduced contact surface with the motor eccentric. The driving bridge comprises opposing ramps 112 to help guide the eccentric driving mechanism into the driving bridge 106 during assembly.

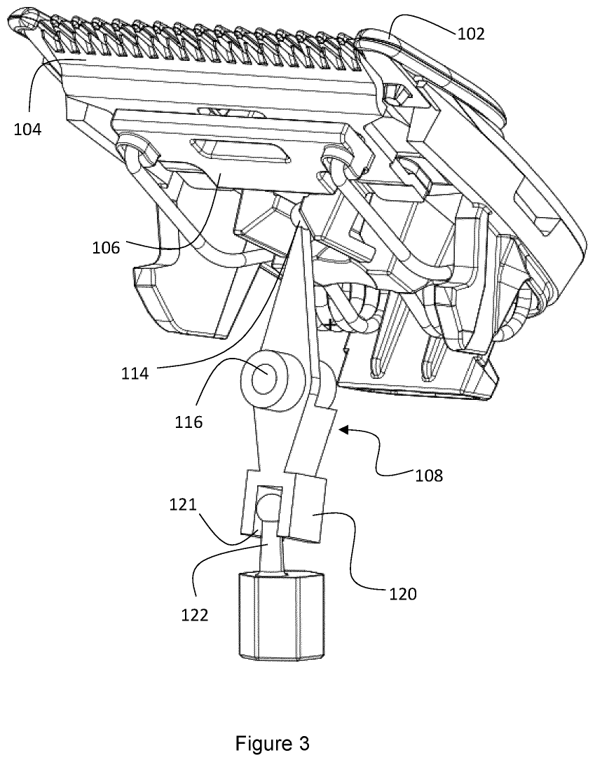

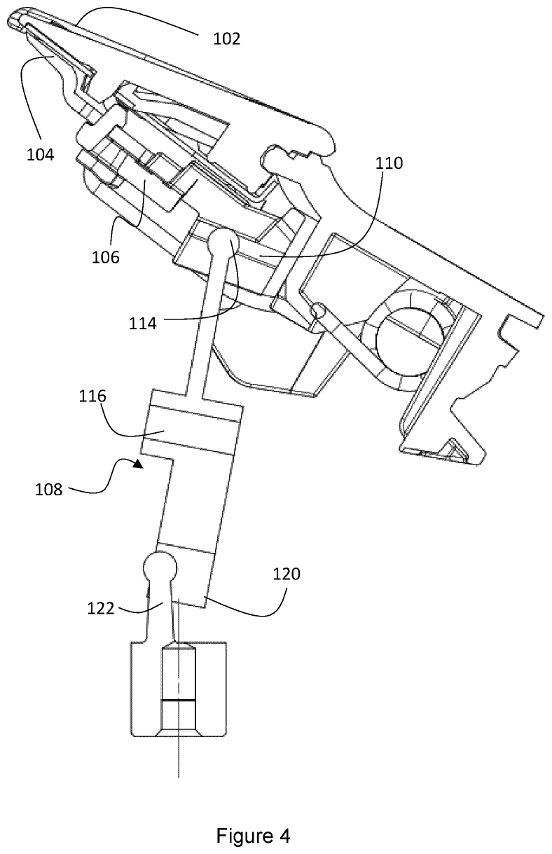

With reference to FIGS. 3 and 4, a personal care appliance is provided where the motor is located further from the driving bridge in comparison to the personal care appliance of FIGS. 1 and 2. In other words, the motor is distal from the driving bridge. To accommodate the distally located motor, the linkage is a lever. The lever includes a tip 114, a hub 116, and a motor end. The tip includes a substantially spherical ball to reduce friction with the driving surfaces. The hub 116 includes a hole for mounting to an axle (not shown) anchored to a handle of the personal care appliance. A centre of a hub provides a rotational axis of the lever.

The motor end 118 includes a fork 120 providing a slot 121 for receiving a motor eccentric 122 therein.

It will be appreciated that stacked tolerances along the personal care appliance cause alignment issues between the tip 114 and the slot 110.

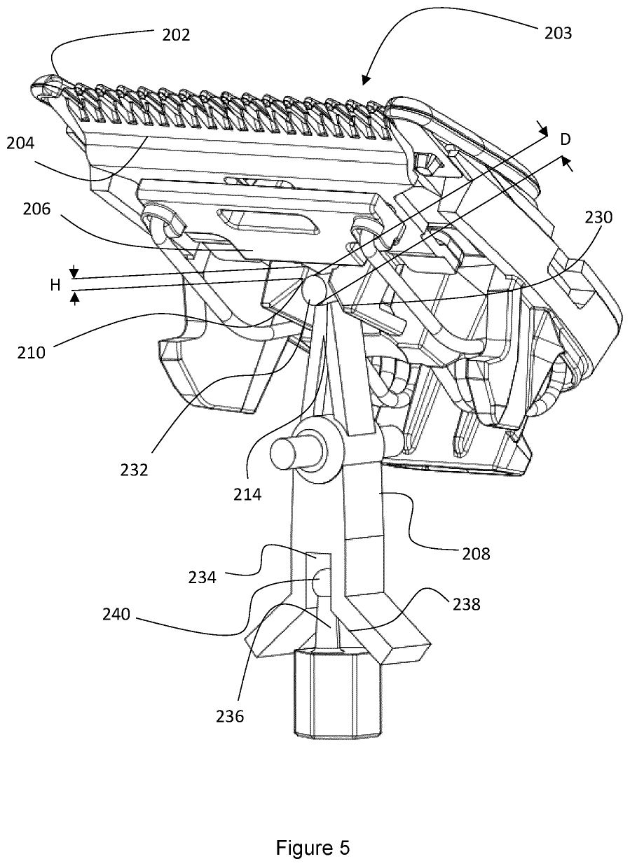

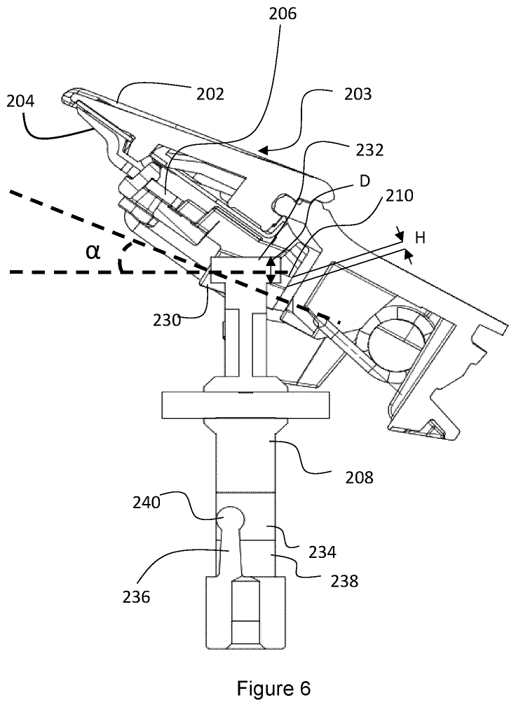

This issue is addressed by the personal care appliance in the form of a shaver of FIGS. 5 to 7. Features not described in relation to FIGS. 5 to 7 but which are common to the personal care appliances described in relation to FIGS. 1 to 4 may be considered to have the same reference sign incremented by 100.

With reference to FIGS. 5 to 7, the personal care appliance comprises a handle (not shown), a functional device 203 at a head of the handle, a driving bridge 206 for driving the functional device, a motor (not shown) within the handle, and a lever 208 between the motor and the driving bridge 206 for reciprocally driving the driving bridge back and forth. The motor is positioned at a distal end of the handle to the head.

The functional device in this case comprises a cutter 204 because the personal care appliance is a shaver. The functional device also includes a guard 202 as in the personal care appliances of FIGS. 1 to 4.

As above, the driving bridge 206 comprises a slot 210. The slot 210 is formed between two opposing surfaces of the driving bridge which may be called driving surfaces. The driving surfaces have a height H. The driving bridge comprises a guide 230 for guiding a tip 214 of the lever 208 into the slot 210 during assembly. The guide 230 includes opposing inclined surfaces.

The lever 208 extends substantially in a same direction as an axis of rotation of the motor, which is substantially the same as an axis in which the handle extends.

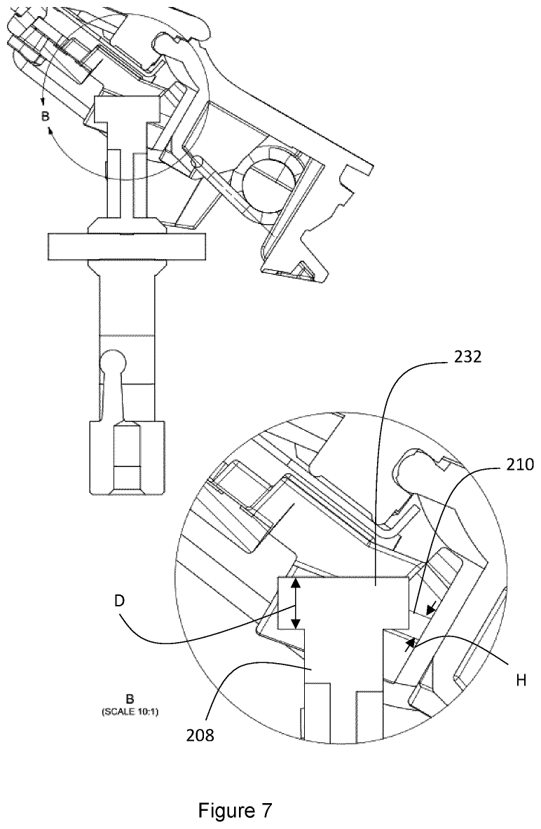

The lever 208 comprises a cylinder 232 at the tip 214. The cylinder 232 has a diameter D. The cylinder 232 is inserted in the slot 210 of the driving bridge 206. The driving bridge 206 is inclined with respect to the cylinder. Put differently, the cylinder 232 is inclined with respective, or relative, to the slot 210. In other words, a direction in which the slot extends is inclined relative to a central axis of the cylinder. In this way, it is easier to align the cylinder 232 with the driving surfaces of the driving bridge 206 compared to a configuration where the slot 210 may extend in a direction parallel to, or in line with, a central axis of the cylinder 232. The central axis of the cylinder 232 may be parallel to an axis of rotation of the lever. Moreover, the diameter D of the cylinder 232 is greater than the height H of the driving surfaces. Thus, the ratio of the diameter D of the cylinder 232 to the height H of the driving surface has a value greater than one. The ratio D/H may range, for example, from 1.2 to 5. The ratio D/H may be for example 1.2, 1.26, 1.5, 2, 2.2, 2.5, 3, 3.4, 4, 4.5, 5, etc. An optimal D/H ratio value to manage manufacturing tolerances may be around 2.2. FIG. 7 shows a D/H ratio of around 2.2. By having a D/H ratio greater than one, the driving bridge 206 used to drive the functional device remains suitable, or in other words, compatible with an eccentric driving mechanism, which comprises an elongated stem of diameter D. Thus, it will be appreciated by those skilled in the art that the inclined driving bridge 206 for driving the functional device may be compatible with personal care appliances that incorporate either an eccentric driving mechanism or a lever 208, as described in the context of the invention.

In some embodiments, an angle of inclination of the cylinder with respect to the driving bridge is between 10 and 30 degrees. The angle of inclination may be around 20 degrees. With this in mind, a length of the cylinder may be between 4 and 8 mm. The length of the cylinder may be governed using formula (1) below.

$$L = \frac{e}{tan α} + L\_start \qquad Formula ( 1 )$$

In formula (1), L is a length of the cylinder in mm, e is an error between a highest and lowest positions of the cylinder in the slot measured in mm, α is the angle of inclination of the cylinder with respect to the slot, and L_start is a starting value for the cylinder length in mm assuming e is zero. The error, e, may be around 1 mm.

The lever 208 may comprise a motor end opposite the tip 214. The motor end may include a slot 234. The motor may comprise an eccentric driving mechanism 236 extending in a direction of an axis in which the handle extends. The eccentric driving mechanism 236 may be accommodated within the slot 234 of the motor end of the lever 208.

The eccentric driving mechanism 236 may comprise a substantially spherical shaped tip 240 contained within the slot 234 of the motor end of the lever 208. The motor end of the lever comprises a guide 238 for guiding the eccentric driving mechanism therein during assembly. The guide 238 of the motor end of the lever comprises opposing ramps.

While the invention has been illustrated and described in detail in the drawings and foregoing description, such illustration and description are to be considered illustrative or exemplary and not restrictive: the invention is not limited to the disclosed embodiments.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measured cannot be used to advantage. Any reference signs in the claims should not be construed as limiting the scope.

1. A personal care appliance comprising:
a handle;
a functional device (204) at a head of the handle;
a driving bridge (206) for driving the functional device, the driving bridge comprising a slot (210);
a motor within the handle; and
a lever (208) coupled between the motor and the driving bridge (206) for reciprocally driving the driving bridge (206) back and forth, the lever (208) comprising a cylinder (232) at a tip inserted in the slot (210) of the driving bridge (206), the slot (210) being provided between opposing driving surfaces;
wherein the cylinder (232) is inclined with respect to the driving bridge (206),
wherein a ratio, D/H, of a diameter, D, of the cylinder to a height, H, of the respective driving surfaces, is greater than one.

2. The personal care appliance of claim 1, wherein an angle of inclination of the cylinder (232) with respect to the driving bridge (206) is between 10 and 30 degrees, and preferably, wherein the angle of inclination is around 20 degrees.

3. The personal care appliance of claim 1, wherein the ratio D/H is around 2.2.

4. The personal care appliance of claim 2, wherein a length of the cylinder (232) is between about 4 and 8 mm.

5. The personal care appliance of claim 4, wherein the length of the cylinder (232) is governed by:
L=e/tan(α)+L_start,
where L is the length of the cylinder (232) measured in mm, e is an error range between a highest and a lowest positions of the cylinder in the slot (210) measured in mm, α is the angle of inclination of the cylinder (232) with respect to the driving bridge (206), and L_start is starting value for the cylinder (232) length in mm assuming e is zero.

6. The personal care appliance of claim 5, wherein the error, e, is around 1 mm.

7. The personal care appliance of claim 1, wherein the cylinder (232) axis is substantially parallel to an angle of rotation of the lever (208).

8. The personal care appliance of claim 1, wherein the lever (208) comprises a motor end opposite the tip (214), the motor end having a slot (234), wherein the motor comprises an eccentric driving mechanism (236) extending in a direction of an axis in which the handle extends, wherein the eccentric driving mechanism (236) is accommodated within the slot (234) of the motor end of the lever (208).

9. The personal care appliance of claim 8, wherein the eccentric driving mechanism (236) comprises a substantially spherical shaped tip (240) contained within the slot (234) of the motor end of the lever (208).

10. The personal care appliance of claim 9, wherein the motor end of the lever (208) comprises a guide (238) for guiding the eccentric driving mechanism (236) therein during assembly.

11. The personal care appliance of claim 10, wherein the guide (238) of the motor end of the lever (208) comprises opposing ramps.

12. The personal care appliance of claim 1, wherein the driving bridge (206) comprises a guide (230) for guiding the tip (214) of the lever (208) to the slot (210) of the driving bridge during (206) assembly.

13. The personal care appliance of claim 12, wherein the guide (230) of the driving bridge (206) comprises opposing inclined surfaces.

14. The personal care appliance of claim 1, wherein the lever (208) extends in a direction substantially parallel to the axis in which the handle extends, and optionally wherein the motor is positioned at a distal end of the handle to the head.

15. The personal care appliance of claim 1, wherein the personal care appliance is a shaver, and the functional device (203) comprises a cutter.
